(19) United States
(12) Patent Application Publication
(10) Pub. No.: US 2006/0071032 A1
(43) Pub. Date: Apr. 6, 2006

(54) Stroke and output limiter for positive displacement pump bottle

(76) Inventors: Nick E. Ciavarella, Seven Hills, OH (US); Lori A. May, Uniontown, OH (US); Mark E. Rosenkranz, Parma, OH (US); Andrew R. Spriegel, Avon, OH (US)

Correspondence Address: Ray L. Weber;Renner, Kenner, Greive, Bobak, Taylor & Weber, Fourth Floor, First National Tower, Akron, OH, 44308-1456, US

(21) Appl. No.: 10/934,053

(22) Filed: Sep. 3, 2004

(51) Int. Cl. G01F 11/06

(52) U.S. Cl. 222/321.7

(57) ABSTRACT

A piston stroke limiter provided in association with a positive displacement pump bottle has a piston restriction clip that may be selectively secured to the piston of the positive displacement pump. The height of the clip limits the stroke of the pump so that less fluid is dispensed from the positive displacement pump bottle than would be dispensed if the clip were removed. A protective overcap is provided in preferred embodiments to protect portions of the positive displacement pump during shipping.

### BACKGROUND OF THE INVENTION

The present invention generally relates to positive displacement pump bottles. More particularly, the present invention relates to a positive displacement pump bottle that includes a piston stroke limiter that serves, in use, to reduce the output of the pump bottle by limiting the stroke length of the pump piston.

Positive displacement pumps are generally known. With reference to FIG. 1, it can be seen that a positive displacement pump bottle is shown and designated by the numeral 10. Positive displacement pump bottle 10 includes bottle 12 that holds the fluid to be dispensed, and positive displacement pump 14 is threaded or otherwise associated with bottle 12 through cap 15 at opening 16 at threads 17. Positive displacement pump 14 includes pump mechanism 18 that, in a known manner, includes valves and biasing elements to dispense the fluid within bottle 12 at spout 19 when piston head 20, on piston 22, is pushed downwardly (see arrow A) from its biased extended position to the depressed position shown in phantom in FIG. 1. As downward pressure is removed from piston head 20, the biasing force urges it upward and fluid is drawn into tube 24 and into pump mechanism 18 so that, when pressure is again applied to piston head 18 in the downward direction, additional fluid may be dispensed. The actual elements of pump mechanism 18, causing it to work as described, are generally well known in many alternative configurations, and the present invention is not limited to any particularly type of pump mechanism 18 or positive displacement pump 14, so long as fluid is dispensed from bottle 12 as generally disclosed.

Positive displacement pump bottles such as pump bottle 10 have a number of uses, and they may be configured to dispense large or small amounts of products in a given stroke. Herein it is to be understood that the “stroke” is the distance that the piston head 20 portion of the positive displacement bottle pump is able to move from its fully extended position to its fully depressed position. Positive displacement pump bottles 10 are generally configured to give a specific unit dose of fluid product per stroke. However, different consumers might want different pump outputs for a given fluid product, thus requiring positive displacement bottle pump manufacturers to supply a number of different pump designs to satisfy individual customer output demands. This leads to higher inventory and higher cost products because of a loss of economies of scale. Additionally, customers desire to have a means by which the dose of fluid dispensed from a positive displacement pump bottle may be selectively altered to dispense either a larger or smaller amount of fluid as desired. Although this might be accomplished by simply pushing down on the piston head to a lesser extent (i.e., practicing a partial stroke), it is desirable that the full stroke of the piston could be employed and yet differing doses could be achieved.

During the shipping of positive displacement pump bottles, it is easy for the piston and piston head to become damaged if a pump bottle is dropped or otherwise jostled. Thus, there exists a need in the art for means for protecting the piston head, piston, and pump mechanisms of a positive displacement pump bottle, especially during packaging and shipping.

### SUMMARY OF THE INVENTION

The present invention provides a positive displacement pump bottle comprising a bottle holding fluid to be dispensed; a positive displacement pump communicating with said fluid, said positive displacement pump including a piston capped with a piston head, wherein said piston and piston head are biased so that said piston head and a portion of said piston extend externally of said bottle and are movable against said bias toward said bottle to dispense fluid according to the distance that said piston head travels against said bias force; and a piston stroke limiter including a piston restriction clip secured to said bottle and selectively clipped to said piston external of said bottle to restrict the distance that said piston head may travel against said bias force.

In particularly preferred embodiments, a positive displacement pump bottle is provided, as above, wherein the piston stroke limiter further includes a storage barrel that allows the piston restriction clip to be conveniently stored when not in use. In other preferred embodiments, a protective cap is releasably secured to the piston stroke limiter, over the piston and piston head. In yet other embodiments, either multiple piston restriction clips are provided or a single piston restriction clip provides differing degrees of stroke limitation.

### BRIEF DESCRIPTION OF DRAWINGS

For a complete understanding of the objects, techniques and structure of the invention, reference should be made to the following detailed description and accompanying drawings wherein:

FIG. 1 is a cross section of a general depiction of a prior art positive displacement pump bottle;

FIG. 2 is a positive displacement pump bottle including a piston stroke limiter according to this invention;

FIG. 3 is a perspective view of a piston stroke limiter according to this invention;

FIG. 4 is a perspective view of a positive displacement pump bottle with a piston stroke limiter according to this invention being employed thereon to limit the stroke of a positive displacement pump;

FIG. 5 is a perspective view as in FIG. 4, but showing the restriction clip of the piston stroke limiter in a stored state;

FIG. 6 is a perspective view of an alternative embodiment of a piston stroke limiter according to this invention;

FIG. 7 is another alternative embodiment of a piston stroke limiter according to this invention that does not employ a protective cap;

FIG. 8A is a top view of yet another embodiment of a piston stroke limiter according to this invention showing the concept of employing multiple clip sizes for limiting the stroke of the pump;

FIG. 8B is a side view of the embodiment of FIG. 8A; and

FIG. 9 is an alternative embodiment for providing multiple clip sizes as in FIG. 8.

### DETAILED DESCRIPTION OF THE PREFERRED EMBODIMENTS

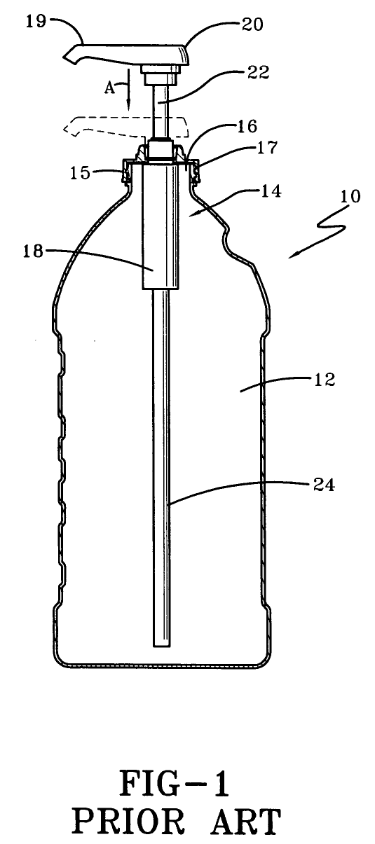

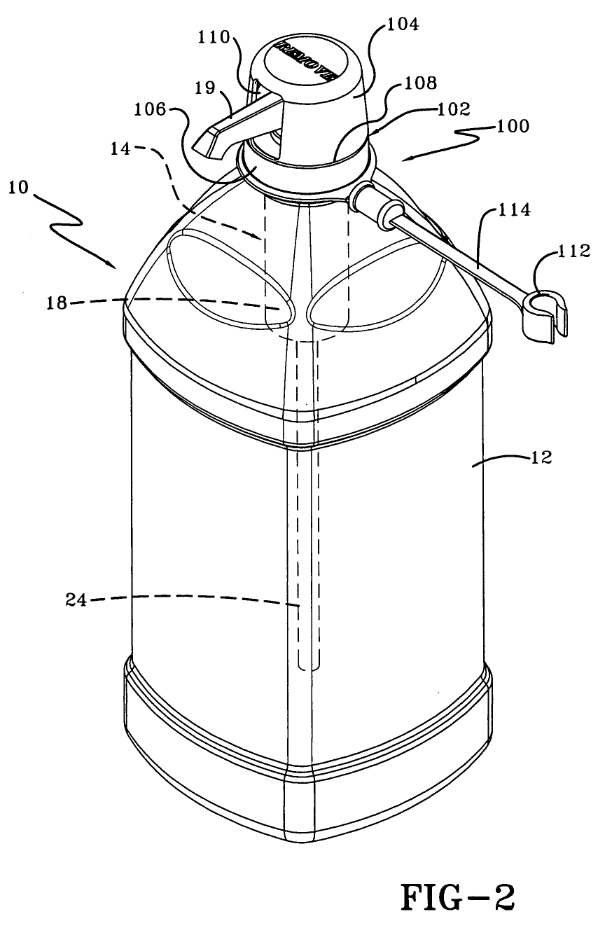

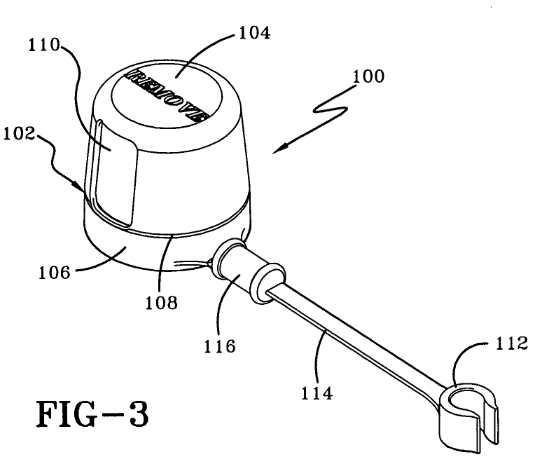

The present invention provides a piston stroke limiter for a positive displacement pump bottle, such as pump bottle 10. With reference to FIGS. 2 and 3, a piston stroke limiter according to this invention is shown and designated by the numeral 100. Piston stroke limiter 100 is selectively secured to positive displacement pump bottle 10 by cap 102 having protective overcap 104 secured to cap collar 106 at breakable franges 108. Spout aperture 110 is formed in protective overcap 104 so that piston stroke limiter 100 may be guided over spout 19 and secured to bottle 12 at opening 16 by fitting cap collar 106 over cap 15 (FIG. 1). Preferably, cap collar 106 will fit over cap 15 through a snap fit.

Piston restriction clip 112 is secured to and held at a distance from cap collar 106 by flexible strap 114. With reference to FIG. 4, it can be seen that piston restriction clip 112 can be secured to the base of piston 22, and, when snapped thereon, physically limits the stroke of piston head 20 when piston head 20 contacts piston restriction clip 112, thus restricting the fluid output. It would be appreciated that different height clips 112 could be employed either individually or together on the same flexible strap 114 to limit the stroke of piston head 20 more or less, as desired. Clip 112, snaps onto piston 22 and can be removed at any time to allow for a full stroke and full fluid output.

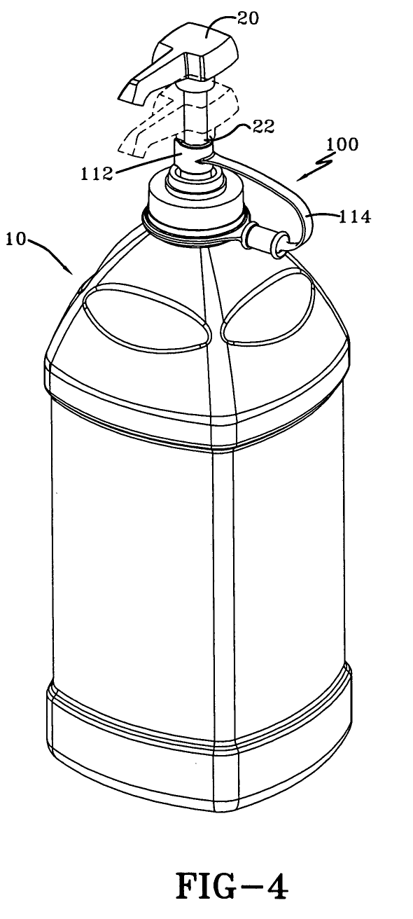

As seen in FIG. 5, when full fluid output is desired, and clip 112 is not to be employed, it may be stored on storage barrel 116, which is sized to receive clip 112 in a snap-on fashion.

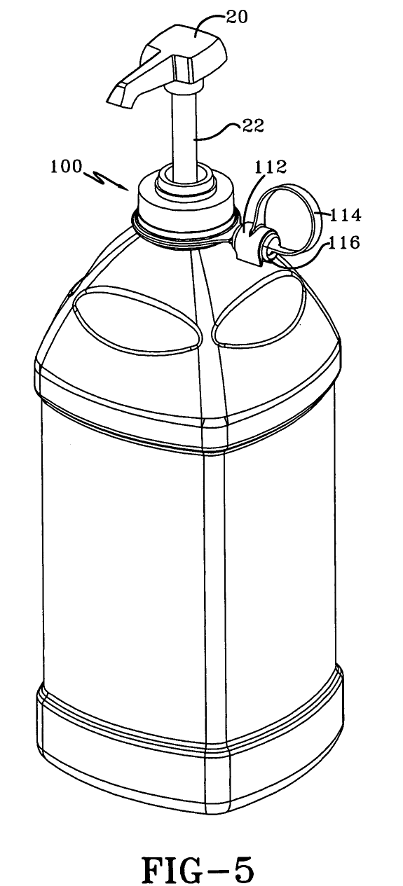

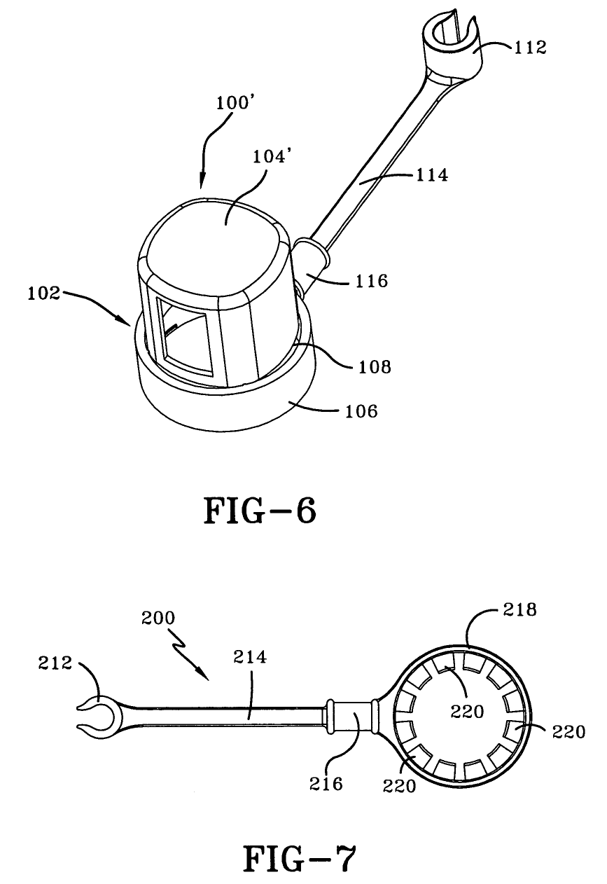

With reference to FIG. 6, it can be seen that overcap 104 of piston stroke limiter 100 may take a different shape, shown therein as overcap 104′ on a limiter 100; with like parts receiving like numerals. This overcap 104′, which has a squared or rectangular cross section, is easier to manufacture, and provides a better grip for breaking breakable franges 108.

In FIG. 7, an alternative embodiment of a piston stroke limiter is shown and designated by the numeral 200. Therein, like parts have received like numerals, but cap 102 is not provided. Rather, flexible strap 214 extends from ring 218. A plurality of teeth 220 extend radially inwardly from ring 218 so that ring 218 may be placed around the neck of a bottle opening (such as opening 16) and be held in place. A cap (e.g., cap 15) of a positive displacement pump (e.g., pump 14) would be threaded onto opening 16 to further secure ring 218.

In FIG. 8, another embodiment of a piston stroke limiter is shown and designated by the numeral 300, and like parts to limiter 200 receive like numerals but increased by 100. In this embodiment, piston restriction clip 312 is stepped, providing multiple levels of piston stroke limitation. In this embodiment, clip 312 has first, second, and third clip sections 330A, 330B, 330C, respectively, each of a different height, with the height increasing, in steps, from the distal section 330A to the section 330C proximate flexible strap 314. Clip 312 thus provides a stepped side 332 and a flat side 334, and would be placed on the piston of a positive displacement pump with the flat side 334 facing upwardly to be the surface with which the piston head makes contact.

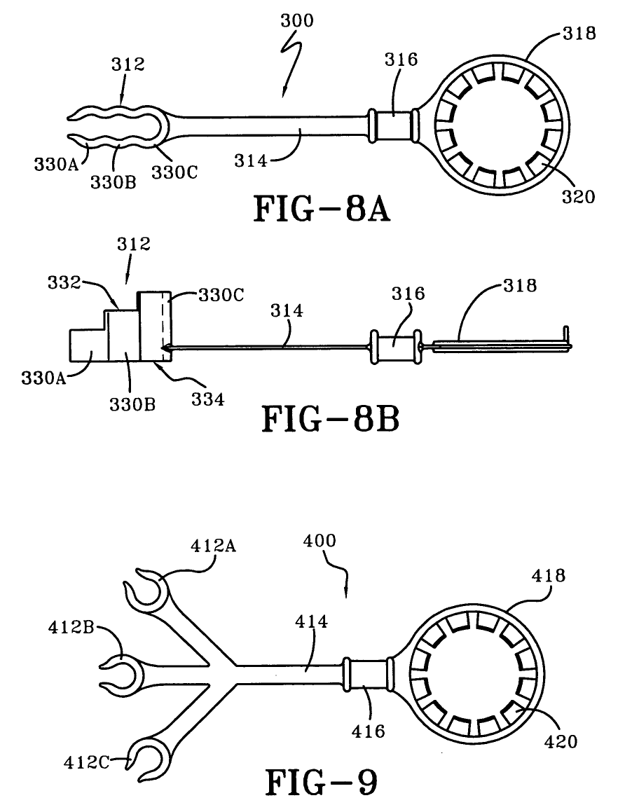

In FIG. 9, yet another embodiment is shown as limiter 400, with like parts having like numerals but in the 400 range. Here, multiple clips 412A, 412B, 412C are provided coming off of strap 414. Each clip 412A, 412B, 412C is of a different height to provide differing levels of stoke limitation.

Although specific embodiments have been shown herein, this invention is not to be limited to or by such embodiments, and it should be appreciated that aspects of one embodiment may be incorporated into another. For example, although the multiple clip embodiments show a ring and teeth collar configuration, the protective overcap and cap collar may be practiced with a multiple clip embodiment. Thus, while a full and complete description of the invention has been set forth in accordance with the dictates of the Patent Statutes, it should be understood that modifications can be resorted to without departing from the spirit hereof or the scope of the appended claims.

What is claimed is:

1. A positive displacement pump bottle comprising:
a bottle holding fluid to be dispensed;
a positive displacement pump communicating with said fluid, said positive displacement pump including a piston capped with a piston head, wherein said piston and piston head are biased so that said piston head and a portion of said piston extend externally of said bottle and are movable against said bias toward said bottle to dispense fluid according to the distance that said piston head travels against said bias; and
a piston stroke limiter including:
a piston restriction clip secured to said bottle and selectively clipped to said piston external of said bottle to restrict the distance that said piston head may travel against said bias.

2. The positive displacement pump bottle of claim 1, wherein said piston restriction clip is removable secured to said bottle.

3. The positive displacement pump bottle of claim 2, wherein said bottle includes an opening and a cap selectively covers said opening; and said piston stroke limiter includes an attachment ring that fits around said opening below said cap, and a strap that secures said piston restriction clip to said attachment ring.

4. The positive displacement pump bottle of claim 1, wherein said piston stroke limiter includes a cap collar and a protective overcap that is connected to said cap collar through a frangible connection, said protective overcap portion fitting over said piston head thereby protecting said positive displacement pump during shipping of the positive displacement pump bottle and requiring removal thereof at said frangible connection in order to employ said positive displacement pump.

5. The positive displacement pump bottle of claim 1, wherein said piston stroke limiter includes a storage barrel that selectively receives said piston restriction clip for storage thereof when not selectively clipped to said piston.

6. The positive displacement pump bottle of claim 1, wherein said piston stroke limiter includes multiple piston restriction clips, each secured to said bottle to be selective clipped to said piston to alter the distance that said piston head may travel against said bias, each one of said multiple piston restriction clips providing a different restriction of the distance that said piston head may travel.

7. The positive displacement pump bottle of claim 6, wherein said multiple piston restriction clips are provided as a stepped piston restriction clip having stepped sections such that a given said stepped section may be selectively clipped to said piston to restrict by a desired increment the distance that said piston head may travel.
